(19) United States
(12) Patent Application Publication
(10) Pub. No.: US 2011/0226022 A1
(43) Pub. Date: Sep. 22, 2011

(54) Security apparatus

(75) Inventor: Michael V. Caldwell, Coarsegold, CA (US)

(73) Assignees: Dennis N. Monahan; Elvin L. Haworth

(21) Appl. No.: 12/661,351

(22) Filed: Mar. 16, 2010

(51) Int. Cl. E05B 73/00; E05B 65/12

(52) U.S. Cl. 70/19

(57) ABSTRACT

A security apparatus for substantially immobilizing a work object rested on a substantially immovable surface, the security apparatus having a body member; arms mounted on the body member disposed in spaced, substantially facing relation to each other and adapted to be positioned in fixed position on opposite sides of the work object; a lock assembly for releasably locking the arms in the fixed position so as to be substantially unitary with the work object; and a disabling member mounted on the body member substantially on the opposite side thereof from the arms whereby any attempt to move the work object is prevented by the disabling member engaging the immovable surface.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field of the Invention

The present invention relates to a security apparatus and, more particularly, to a security apparatus which is operable to prevent the theft or other unauthorized movement of an automotive vehicle.

(2) Description of the Prior Art

The prior art is replete with various devices designed to render an automotive vehicle unusable as a security measure and without damage, or easily repairable damage, to the vehicle. A variety of environments exist in which such devices are used. One such environment is, of course, where the owner of the automotive vehicle uses such a device in an effort to prevent the vehicle from being stolen, where for example the vehicle to be parked on a city street.

Another environment of use is when law enforcement authorities wish to disable an automotive vehicle which has been, or will be impounded. In other instances the owner of the vehicle, for example, may have been cited for driving violations on numerous occasions and has not paid the resulting tickets. Seizing the vehicle or immobilizing it in such a way, may exert enough pressure on the individual to cause such tickets to be paid.

In any case, it is known to attempt to lock a vehicle in position from the exterior without having to get access to the interior of the vehicle. A variety of types of devices have been designed to be attached to one of the wheels of the vehicle to prevent movement. Such devices grasp the wheel and tire thereon and lock them in position. Typically they are cumbersome and difficult to install and to remove. Other types of prior art devices operate to damage the vehicle if movement is attempted. Still other types of devices will not fit all but a minimum number of sizes of tires and wheels. In addition, prior art devices can be defeated by breaking the operative part of the locks which are typically fully or partly exposed. In some instances, thieves inject a cryogenic liquid into the lock. This renders the metal brittle and subject to breakage when struck, for example, with a hammer or the like. In all of these devices and others there are significant problems with their use. These problems may result in the devices ultimately not being used.

Therefore, it has long been known that it would be desirable to have a security apparatus which was not cumbersome but rather was readily maneuvered during use; which was light weight and easily installed; which was not subject to means for defeating its purpose and effectiveness in use; which would fit a wide variety of sizes of wheels; which could not be pried off or otherwise defeated by unauthorized people; and which was otherwise successful in achieving its operational objectives.

### BRIEF SUMMARY OF THE INVENTION

Therefore, it is an object of the present invention to provide an improved security apparatus.

Another object is to provide such a security apparatus which can be operated rapidly and dependable to immobilize an automotive vehicle and the like.

Another object is to provide such a security apparatus which is not cumbersome in use, but rather is readily installed with little or no instruction or strain.

Another object is to provide such a security apparatus which is readily adjustable to fit most tires and wheels of automotive vehicles.

Another object is to provide such a security apparatus which is substantially impervious to techniques which have been used by unauthorized persons in an effort to steal an automotive vehicle.

Another object is to provide such a security apparatus which is not susceptible to the use of cryogenic substances to permit breaking of the locking mechanism thereof.

Another object is to provide such a security apparatus which is operable to disable a vehicle by several different methods all of which are dependable in use.

Another object is to provide such a security apparatus which can be manufactured and sold at relatively low cost so as to be of wide application and use.

Another object is to provide such a security apparatus which can be stored in a confined area so as to be readily available for use when desired.

Further objects and advantages are to provide improved elements and arrangements thereof in an apparatus for the purposes described which is dependable, economical, durable and fully effective in accomplishing its intended purposes.

These and other objects and advantages are achieved, in the preferred embodiment of the present invention, in a security apparatus for substantially immobilizing a work object rested on a substantially immovable surface, the security apparatus having a body member; arms mounted on the body member disposed in a spaced, substantially facing relation to each other and adapted to be positioned in fixed position on opposite sides of the work object so as to be substantially unitary with the work object; and a disabling member mounted on the body member substantially on the opposite side thereof from the arms whereby any attempt to move the work object is prevented by the disabling member engaging the immovable surface.

### BRIEF DESCRIPTION OF THE SEVERAL VIEWS OF THE DRAWINGS

FIG. 1 is a fragmentary side elevation of an automotive vehicle with the security apparatus or the present invention installed thereon in a typical operational environment.

FIG. 2 is a somewhat enlarged fragmentary section taken on line 2-2 in FIG. 1 and also showing one of the arms of the security apparatus in phantom lines in an extended position.

FIG. 3 is a perspective view of the security apparatus of the present invention.

FIG. 4 is a perspective view of the security apparatus with one of the arms thereof shown in a second operative position.

FIG. 5 is a somewhat enlarged, transverse vertical section taken on line 5-5 in FIG. 3.

FIG. 6 is a somewhat enlarged, horizontal section taken on line 6-6 in FIG. 3.

### DETAILED DESCRIPTION OF THE INVENTION

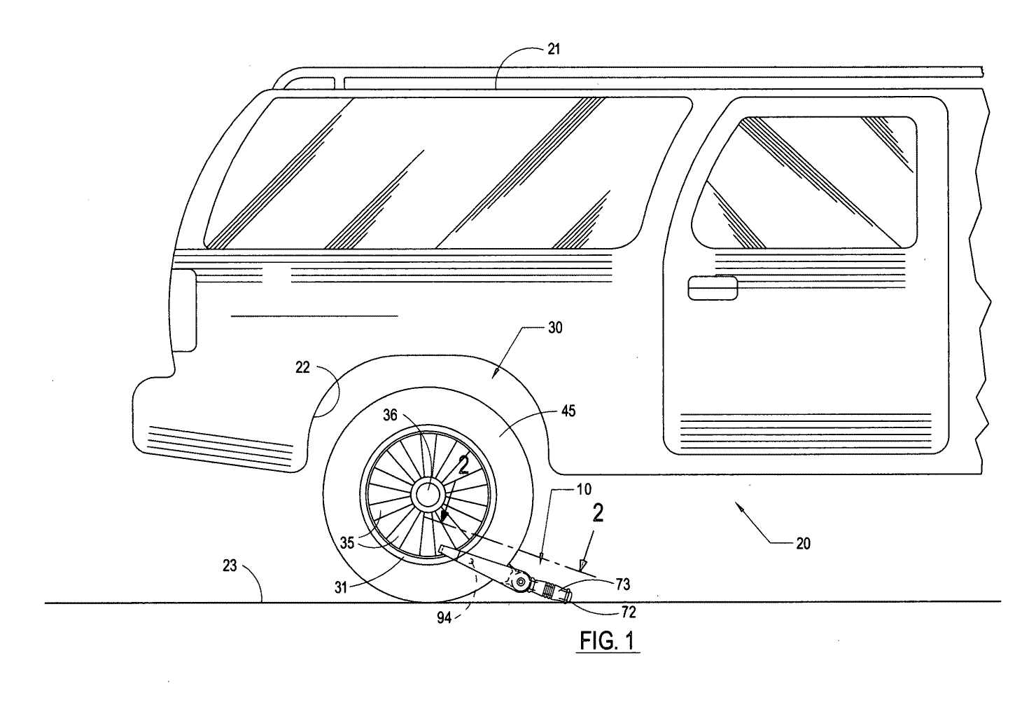

Referring more particularly to the drawings, the security apparatus of the present invention in generally indicated by the numeral 10 in FIG. 1.

The security apparatus 10 is shown in FIG. 1 in a typical operative environment in use on an automotive vehicle 20. The automotive vehicle, for reference purposes, can be viewed as having a rearward portion 21 and has a rear wheel well 22 visible in FIG. 1. A roadway is generally indicated at 23.

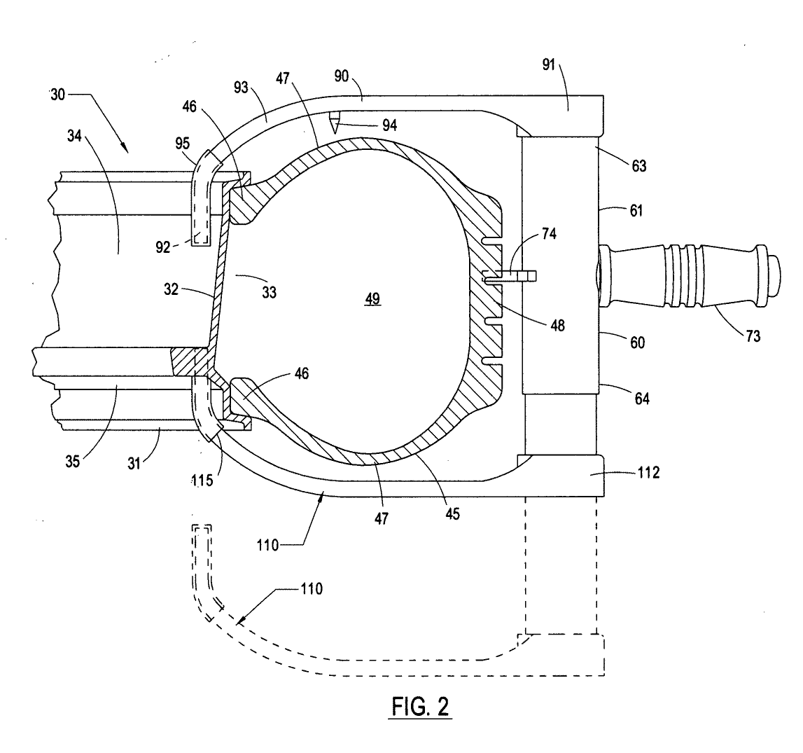

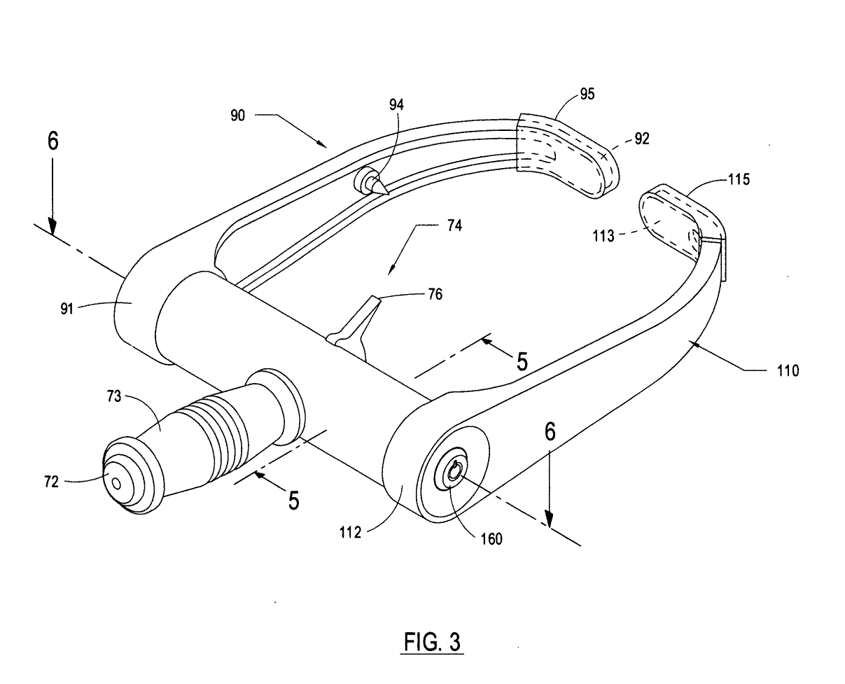

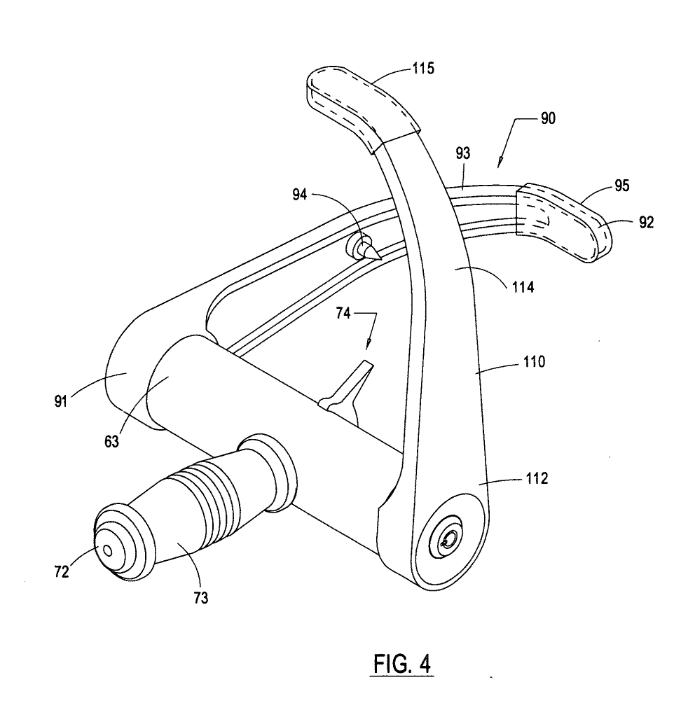

The vehicle 20 has a right rear wheel 30. A portion of the right rear wheel is shown in cross section in FIG. 2. The wheel has a circular rim 31 having a peripheral member 32. Externally, the peripheral member defines a tire channel 33. The wheel has an interior 34 in which a plurality of spoke members extend radially to the peripheral member 32. The spoke members radially extend from a hub 36 which is mounted on the axle, not shown, of the wheel.

A tire 45 is mounted on the wheel 30 in the conventional manner. The tire has annular mounting portions 46 which are received in the tire channel 33 of the peripheral member 32, a best shown in FIG. 2, and extend thereabout in mounted relation. The tire has opposite sidewalls 47 and a tread portion 48. The tire channel 33, sidewalls 47 and tread portion 48 bound an air chamber 49 which is, as shown and described herein, pressurized with air.

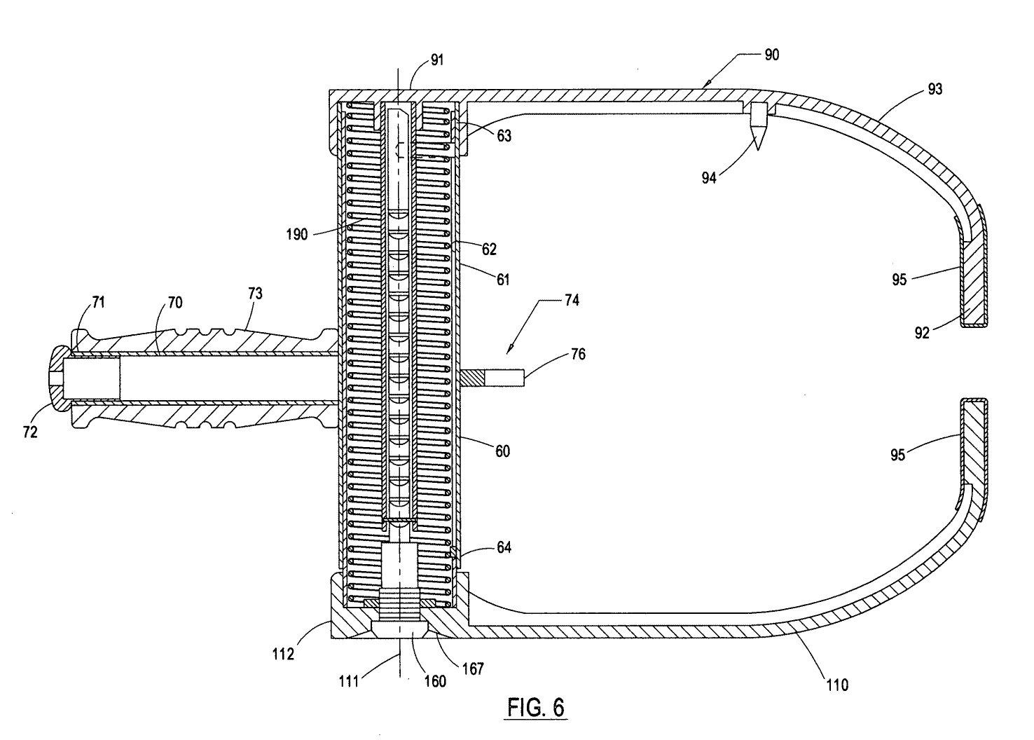

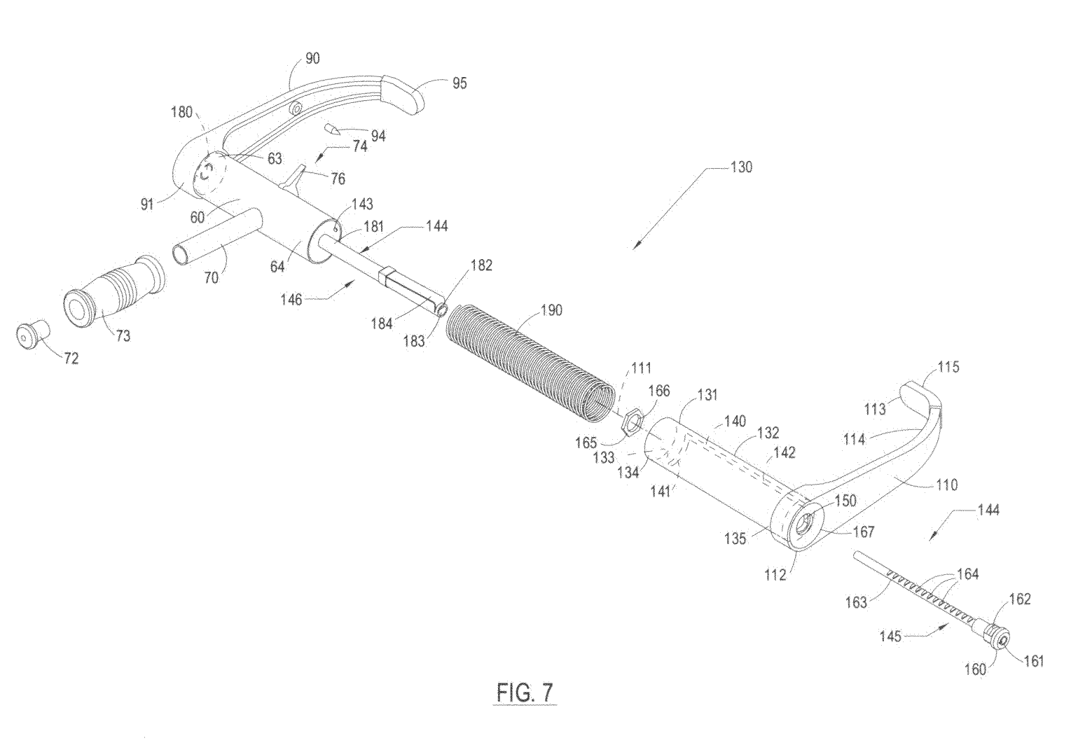

The security apparatus 10 of the present invention is, perhaps shown best in FIGS. 2 and 6. The security apparatus has a first cylinder 60 having a substantially cylindrical external surface 61 and substantially cylindrical internal surface 62. As best shown in FIG. 2 the first cylinder has an interior end portion 63 and an opposite exterior end portion 64. The words “interior” and “exterior” refer to the relative positions of the end portions 63 and 64 when the security apparatus is installed as shown in FIG. 2 and as hereinafter described. As shown therein, the inside surface of the wheel is on the left and the outside surface is on the right.

A stop member or metal tubular extension 70 is mounted, as by welding, on the external surface 61 of the first cylinder extending to the left, as viewed in FIG. 6. The tubular extension 70 has a terminal end portion 71 in which is mounted a stop 72. A handle grip 73 is mounted on and extends about the tubular extension 70, as best shown in FIG. 6.

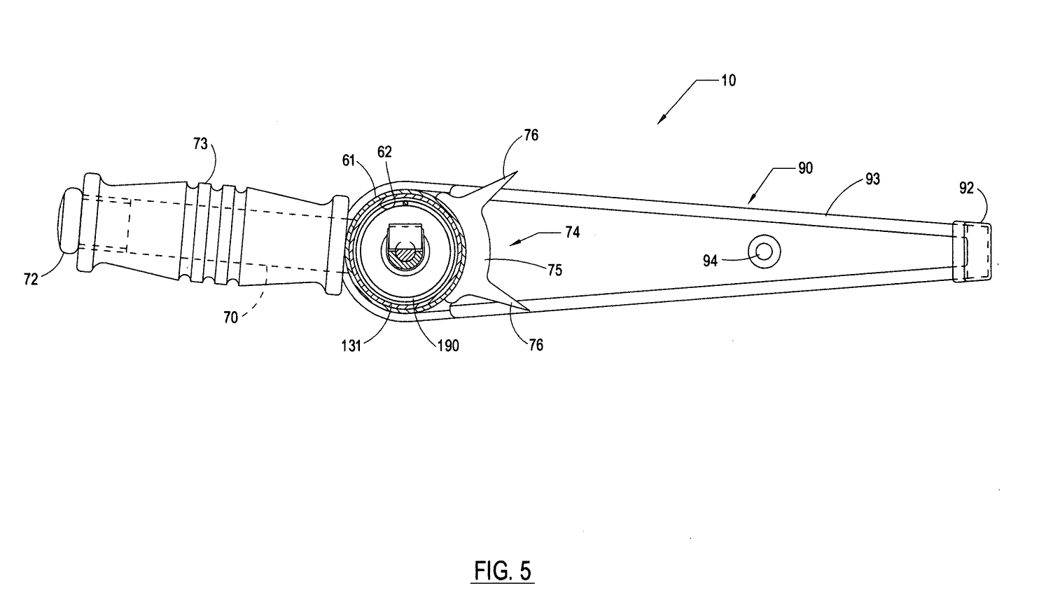

The security apparatus 10 has a puncturing assembly 74 best shown in FIG. 5. The puncturing assembly is mounted, as by welding, or using setscrews, on the external surface 61 of the first cylinder 60 of the security apparatus. The puncturing assembly is mounted on the opposite side of the first cylinder 60 from the tubular extension 70. The puncturing assembly has a body portion 75 from which extend two puncturing prongs 76. The puncturing prongs are disposed at an angle relative to each other, as shown in FIG. 5. The reason for this and the operation thereof will subsequently be discussed in greater detail.

A first arm assembly 90 is mounted, as by welding, on the interior end portion 63 of the first cylinder. The first arm assembly has a mounting end portion 91 which is mounted on the interior end portion 63. The first arm assembly has an opposite terminal end portion 92. The first arm assembly, between the mounting end portion and the terminal end portion, is curved inwardly as best shown in FIG. 2. This forms the curved portion 93 extending therebetween. The first arm assembly has a screwthreadably mounted prong 94 which faces inwardly in the direction of the second arm assembly hereinafter to be described. The prong 94 is operable to puncture the sidewall of the tire if a person attempts laterally to pull the apparatus from the wheel 45. In the event it is not desired that this eventually be possible, the prong 94 can simply be screwthreadably removed from the first arm assembly before use. The terminal end portion 92 and a portion of the curved portion 93 is rubber or plastic coated end portion 95.

A second arm assembly 110 is mounted on the first cylinder 60 of the security apparatus 10, as is hereinafter described. The second arm assembly is mounted for movement about an axis of reference 111 relative to the first arm assembly and the first cylinder 60 under the conditions hereinafter set forth. Referring more particularly to FIGS. 6 and 7, the second arm assembly has a mounting end portion 112 and an opposite terminal end portion 113. Intermediate the mounting end portion and the terminal end portion is a curved portion 114. The terminal end portion has a rubber or plastic coated end portion 115.

The first arm assembly 90 and the second arm assembly 110 are mounted for movement relative to each other and the axis of reference 111 by an interlocking assembly generally indicated by the numeral 130. The interlocking assembly is best shown in FIGS. 6 and 7 and includes a second cylinder 131 having an external surface 132 and an internal surface 133. The external surface 132 of the second cylinder 131 is of slightly smaller diameter than the interior surface 62 of the first cylinder. The second cylinder is slidably received in the first cylinder.

The second cylinder has in interior end portion 134 and an exterior end portion 135. The words “interior” and “exterior” refer to the positions of the end portions 134 and 135 when the security apparatus is installed as shown in FIG. 2 and as hereinafter described. As shown therein, the inside surface of the wheel is on the left as viewed therein and the outside surface is on the right. The second cylinder is mounted on the mounting end portion 112, as by welding, and is substantially concentric to the axis of reference 111.

The external surface 132 of the second cylinder 131 has a recessed track 140 thereon as best shown in FIG. 7. The recessed track has an accurate segment 141 and a longitudinal segment 142 which are interconnected. A track follower or pin 143 is mounted on and extends inwardly from the internal surface 62 of the first cylinder 60. The track pin is dimensioned to be received in the recessed track 140 of the second cylinder and smoothly to follow the accurate segment 141 and the longitudinal segment 142, as will hereinafter be described. More specifically, the first cylinder and second cylinder are moveable toward and from each other substantially concentric to the axis of reference and as controlled by the engagement of the track pin in the recessed track 140.

The interlocking assembly 130 has an internal latch mechanism generally indicated by the numeral 144 in FIG. 7. Since FIG. 7 is an exploded view for illustrative convenience, the portions of the latch mechanism appear therein to be separated from each other to a substantial degree. In reality, the components of the interlocking assembly 130, in operational form, are in interconnected juxtaposition, as shown in FIG. 6.

The internal latch mechanism 144 is composed of a male assembly 145 and an opposite female assembly 146. An opening extends through the mounting end portion 112 of the second arm assembly 110 in a predetermined location.

The assembly 145 has a lock 160 which, in turn has a key slot 161 adapted to receive a key, not shown, for operating the lock. The lock is circumscribed by screwthreads 162. A lock arm 163 is mounted on the lock and extends inwardly therefrom, as best shown in FIG. 7. The lock arm has a plurality of catches or slots 164 extending along the upper surface of the lock arm and disposed in predetermined spaced relation to each other. The male assembly extends into the opening 150 and is mounted in position by a lock nut 165 having internal screwthreads 166. The lock nut 165 securely mounts the male assembly in place by the internal screwthreads thereof screwthreadably engaging the external screwthreads about the lock 160 and being tightened into position.

The second arm assembly 110 has a downwardly tapered circular recess 167 substantially concentric to the lock 160 in the above-identified locked position, as best shown in FIGS. 6 and 7. As shown therein, all of the lock is recessed substantially at the apex of an inwardly tapered surface. The dimensions of the recess are such that the lock cannot be struck with a conventional hammer or other such object which could otherwise be used to break the lock.

The female assembly 146 has a mounting sleeve 180 which is mounted in and extends outwardly from the mounting end portion 91 of the first arm assembly 90, as shown in FIG. 6. The mounting sleeve is itself mounted in the position described by any suitable means such as by welding. The female assembly has a mounting shaft 181 which is slidably received in the mounting sleeve 180 and mounts a spring housing 182 on the terminal end thereof. The spring housing 182 has an entrance opening 183 adapted to receive the lock arm 163 of the male assembly 145 therewithin. A spring loaded clip 184 is mounted on the spring housing 182 and operable to engage the slots 164 of the lock arm 163 of the male assembly 145 to lock the first arm assembly 90 and the second arm assembly 110 in a selected position relative to each other. The lock arm 163 and mounting shaft 181 are lockably held in that position by the lock 160 from which it is releasably operable only by means of the correct key, not shown.

A coil compression spring 190 is resiliently capture within the first cylinder 60 and second cylinder 131 to urge the first arm assembly 90 and the second arm assembly 110 apart when the lock 160 is released.

### OPERATION

The operation of the described embodiment of the present invention is believed to be readily apparent and is briefly summarized at this point.

The security apparatus 10 is mounted in position for use in the position and attitude shown in FIG. 1. Such mounting of the apparatus is achieved by unlocking the lock 160 using the key, not shown. This permits the lock arm 163 of the male assembly 145 to be rotated so that the spring loaded clip 184 of the female assembly 146 to be freed from the slots 164 of the lock arm 163.

This frees the first arm assembly 90 and second arm assembly 110 to be separated from each other, as shown phantom lines in FIG. 2, or pivoted relative to each other, as shown in FIG. 4, or both. In this manner the first and second arm assemblies can be positioned about the right rear wheel 30 and tire 45, or any of the other wheels in the same. The security apparatus is then positioned as shown in full lines in FIG. 2. The lock 160 is employed to lock the first and second arm assemblies in the selected position using the lock's key, not shown. The slots 164 of the lock arm 163 are thereby caused to be engaged by the spring loaded clip 184 to achieve the locked condition.

As shown in FIG. 2, this locked position positions the stop prong 94 adjacent to the sidewall 47 of the tire 45; the first and second arm assemblies in surrounding engagement with the wheel 30 and tire 45 with the second arm assembly 110 extending through the spoke members 35; the rubber coated end portions of the first and second arm assemblies in protective prongs 76 into contact with the tread portion 48 of the tire; and the tubular extension into contact with the roadway 23, all as shown in FIG. 1.

As can, perhaps, best be visualized in FIGS. 1 and 5, the puncturing prongs 76 bear a unique relationship to the tabular extension 70. The puncturing prongs 76 diverge from each other substantially radially relative to the first and second cylinders 60 and 131 respectively. The tubular extension 70 on the other hand extends radially from the first and second cylinders, but in a direction opposite to the puncturing prongs 76. Thus, as shown in FIG. 1, when the end of the tubular extension 70 engages the roadway 23, the puncturing prongs engage the tread portion 48 of the tire at opposite slightly oblique angles.

Once installed as described, the security apparatus 10 has several safety effects preventing theft, or achieving impoundment of the vehicle. The tubular extension 70, when installed as shown in FIG. 1, prevents the automotive vehicle from being driven forwardly because of the interference of the roadway and/or of the real wheel well 22.

Because of the relationship heretofore described of the puncturing prongs 76 and the tubular extension 70, attempted movement of the automotive vehicle forwardly causes the upper puncturing prong to impale the tire. Conversely, attempted movement in a rearward direction causes the lower puncturing prong to impale the tire. Referring to FIG. 2, pulling of the security apparatus form the side of the tire will cause the prong 94 to impale the tire.

Since the lock 160 is recessed as heretofore described, breaking of the lock by striking it, with or without the attempted use of cryogenic material cannot be achieved.

Notwithstanding the foregoing, placement of the security apparatus 10 on the wheel, or removal of it from the wheel will not damage the wheel or tire because of the foregoing construction as well as because of the rubber or plastic coated end portions 95 and 115 providing protective contact with the wheel and tire.

Therefore, the security apparatus of the present invention is not cumbersome but rather is readily maneuverable during use; is light weight and easily installed; is not subject to means for defeating its purpose and effectiveness in use; fits a wide variety of sizes of wheels; cannot be pried off or otherwise defeated by unauthorized people; and is otherwise fully successful in achieving its operational objectives.

Although the invention has been herein shown and described in what is conceived to be the most practical and preferred embodiment, it is recognized that departures may be made therefrom within the scope of the invention which is not to be limited to the illustrative details disclosed.

Having described my invention, what I claim as new and desire to secure by Letters Patent is:

1. A security apparatus for substantially immobilizing a work object rested on a substantially immovable surface, the security apparatus comprising a body member; arms mounted on the body member disposed in spaced, substantially facing relation to each other and adapted to be positioned in fixed position on opposite sides of the work object; means for releasably locking the arms in said fixed position so as to be substantially unitary with the work object; and a disabling member mounted on said body member substantially on the opposite side thereof from the arms whereby any attempt to move the work object is prevented by the disabling member engaging said immovable surface and or work object.

2. The security apparatus of claim 1 wherein said disabling member is an elongated member mounted on the body member of the security apparatus and the work object is a wheel of a vehicle which is prevented form rotating by said elongated member engaging said immovable surface and or work object.

3. The security apparatus of claim 1 in which said work object is a wheel, having a inflated tire mounted thereon, of a vehicle and wherein a puncturing member is mounted on the body member in position to puncture said tire in the event of an attempt to move the vehicle.

4. The security apparatus of claim 3 wherein there are two puncturing members mounted on the body member and extending in directions such that movement of the wheel in either a clockwise or a counterclockwise direction will cause puncturing of said inflated tire.

5. The security apparatus of claim 4 in which said immovable surface is a roadway and wherein said disabling member has an elongated member mounted on and extended from the opposite side of said body member for engagement with said roadway substantially to prevent rotation of said wheel in either a clockwise or a counterclockwise direction in an attempt to move said vehicle.

6. The security apparatus of claim 5 wherein one of said arms is mounted on the body member for selected movement between an open position at an angle relative to the other of said arms to permit said security apparatus to be moved to and from an installed position with at least one of said arms extending about a portion of the wheel.

7. The security apparatus of claim 6 wherein said one of said arms in said installed position is disposed so that both arms are disposed in spaced relation to each other extending about opposite sides of the wheel.

8. The security apparatus of claim 7 wherein a lock assembly operably interconnects said movable arm and the body member operable releasably to lock the security apparatus in the installed position and operable to be placed in an unlocked condition for installation or removal of the security apparatus to permit the arm to be moved to and from said installation position.

9. The security apparatus of claim 8 wherein said lock assembly is recessed within a depression in said arm so as to be protected from tampering therewith in an effort to remove the security apparatus from said wheel.
